(19) United States
(12) Patent Application Publication
(10) Pub. No.: US 2008/0236010 A1
(43) Pub. Date: Oct. 2, 2008

(54) Torsion spring base for deflectable sign

(76) Inventor: Eugene Levin, Livonia, MI (US)

Correspondence Address: HARNESS, DICKEY & PIERCE, P.L.C., P.O. BOX 828, BLOOMFIELD HILLS, MI, 48303, US

(21) Appl. No.: 11/732,099

(22) Filed: Apr. 2, 2007

(51) Int. Cl. E01F 9/017; B23P 19/00; B23Q 3/00

(52) U.S. Cl. 40/608; 269/329; 29/700

(57) ABSTRACT

A deflectable sign spring base includes a bracket. A torsion spring between walls of the bracket walls includes first and second spring posts. The first spring post contacts a first bracket edge and the second spring post contacts an opposed second bracket edge. Spacing between the first and second edges is greater than the spring post spacing for a non-loaded spring. Spring post engagement with the edges separates the spring posts and induces a torsion spring preload force. A mast engaging member is rotatably connected to the bracket and in continuous contact with both spring posts. The member and mast are continuously urged to a vertical orientation by the torsion spring preload force until acted on by a second force overcoming the preload force, the preload force thereafter returning the member and mast to the vertical orientation after the second force is removed.

### FIELD

The present disclosure relates to a torsion spring support member for coupling an upright sign member to a base.

### BACKGROUND

The statements in this section merely provide background information related to the present disclosure and may not constitute prior art.

Numerous sign stand devices have been designed for displaying advertisements and information to the public. These signs are typically positioned on an upright member that is either anchored in the ground, held in place by sand bags or other heavy objects, or spring-mounted on bases which allow the upright member to bend or deflect relative to the base, without tipping over, under high wind forces.

Some common sign stands have a single spring as the resilient member for coupling the upright member to the base. These prior designs commonly permit relative movement between the resilient member and upright member and/or base before the load from the sign is coupled to the resilient member. Such prior art sign stands are susceptible to damage from prolonged exposure to high winds. This damage typically results from repeated torque moments and hammer effect created by the force of the wind acting against the sign due to the increased force created by the acceleration of the upright member prior to striking the arm of the resilient member. Some designs couple the resilient member to the upright member and/or base by one or more threaded fasteners. The above acceleration and hammer action generated by the wind against the sign can produce a continuously varying force that will work against these fasteners, causing them to loosen. The loosening of these fasteners causes a corresponding reduction in the clamping force exerted by the fasteners, thus exacerbating the relative movement at the interface between the upright member and/or base and the resilient member. The relative movement between the resilient member and upright member and/or base can damage the fastener as well as the abutting surfaces.

In view of this problem, multiple designs have been developed which utilize dual springs, or in the case of a single spring, welded connections wherein the resilient member would either be welded directly to the upright member and/or base or to a structural member, such as a length of square tubing, which would receive the upright member to couple it to the base. While the welded connection provided improved resistance to the torque moment produced by the wind, the welded connection was susceptible to fatigue and fracture due to the cyclic nature of wind forces. Additionally, the welded connection prevented the servicing of worn or damaged components, requiring instead the wholesale replacement of significant assemblies rather than just the damaged components.

With respect to the sign stand design which utilizes two springs, this design allows the moment produced by the wind forces to be absorbed by the two springs which are laterally offset from the axis of the upright member. While this design has significantly reduced the occurrence of damage to sign stands resulting from prolonged exposure to high winds, several drawbacks have been noted. These drawbacks include increased weight, increased size, additional fabrication labor and additional cost which are a byproduct of the duplication involved by including the second spring assembly.

### SUMMARY

According to several embodiments of a torsion spring base for a deflectable sign of the present disclosure, a deflectable sign spring base includes a bracket defining a substantially rectangular shape having opposed first and second walls. A horizontally configured torsion spring is positioned between the first and second walls. The torsion spring has first and second spring posts, the first spring post in contact with a first edge of the bracket and the second spring post in contact with an opposed second edge of the bracket. A spacing between the first and second edges is greater than a spring post spacing in a spring non-loaded condition, such that engagement of the first and second spring posts with the first and second edges separates the spring posts and induces a preload force in the torsion spring through the first and second spring posts.

According to additional embodiments, a deflectable sign spring base includes a substantially rectangular-shaped bracket having opposed first and second bracket walls. A horizontally configured torsion spring is disposed between the bracket walls and has first and second spring posts. The first spring post is in contact with a first edge of the bracket and the second spring post is in contact with an opposed second edge of the bracket. A spacing between the first and second edges is greater than a spring post spacing in a spring non-loaded condition, such that engagement of the first and second spring posts with the first and second edges separates the spring posts and induces a preload force in the torsion spring. A member adapted to engage a sign support mast is rotatably connected to the bracket and in continuous contact with both the first and second spring posts. The member and the sign support mast are continuously urged to a substantially vertical orientation by the preload force of the torsion spring until acted on by a second force operable to overcome the preload force, the preload force thereafter being operable to return the member and the sign support mast to the vertical orientation following removal of the second force.

According to still further embodiments, a fixture adapted for assembling a deflectable sign spring base includes a first bracket support member adapted to releasably retain a first bracket portion and a torsion spring. The torsion spring has a first spring post in contact with the first bracket portion. A second bracket support member adapted to releasably retain a second bracket portion is in contact with a second spring post. A rotation inducing member operable to rotate the second bracket portion is connected to the second bracket support member to induce a preload force in the torsion spring through the first and second spring posts.

According to yet still further embodiments, a method for configuring a deflectable sign spring base is provided.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a front elevational view of a torsion spring base for a deflectable sign of the present disclosure;

FIG. 2 is a perspective view of the torsion spring base of FIG. 1;

FIG. 3 is a side elevational view of the torsion spring base of FIG. 1;

FIG. 4 is an end elevational view of the torsion spring base of FIG. 1;

FIG. 5 is a side elevational view of another embodiment of a torsion spring base of the present disclosure;

FIG. 6 is an end perspective view of a sub-assembled portion of the torsion spring base of FIG. 5;

FIG. 7 is a front elevational view of the sub-assembled portion of the torsion spring base of FIG. 6;

FIG. 8 is a side perspective view of another embodiment of a torsion spring base of the present disclosure;

FIG. 9 is a side perspective view of a rectangular bracket assembly of the present disclosure;

FIG. 10 is an exploded assembly view of the bracket assembly of FIG. 9;

FIG. 11 is a side perspective view of a fixture adaptable to assemble the bracket assembly of FIG. 9;

FIG. 12 is a side elevational view of the fixture of FIG. 11;

FIG. 13 is a top plan view of the fixture of FIG. 11;

FIG. 14 is a side perspective view of the fixture of FIG. 11 further showing a sub-assembly step prior to welding;

FIG. 15 is a side elevational view of the fixture of FIG. 14;

FIG. 16 is a side perspective view of the fixture of FIG. 11 further showing a final assembly step and removal of the completed bracket assembly;

FIG. 17 is a side perspective view of another embodiment of a torsion spring base of the present disclosure;

FIG. 18 is a perspective view of the torsion spring base of FIG. 16 having attached legs in a stowed position;

FIG. 19 is a perspective assembly view of the torsion spring base of FIG. 25 having the legs in the stowed position;

FIG. 20 is a perspective view of another embodiment of a fixture for assembling torsion spring bases of the present disclosure;

FIG. 21 is a perspective view of the fixture of FIG. 20 showing a first assembly step;

FIG. 22 is a perspective view of the fixture of FIG. 20 showing a second assembly step;

FIG. 23 is a perspective view of the fixture of FIG. 20 showing a final assembly step;

FIG. 24 is a side perspective view of a still further embodiment of a rectangular bracket assembly of the present disclosure; and

FIG. 25 is a side elevational view of another embodiment of a torsion spring base of the present disclosure.

### DETAILED DESCRIPTION

The following description is merely exemplary in nature and is not intended to limit the present disclosure, application, or uses. It should be understood that throughout the drawings, corresponding reference numerals indicate like or corresponding parts and features.

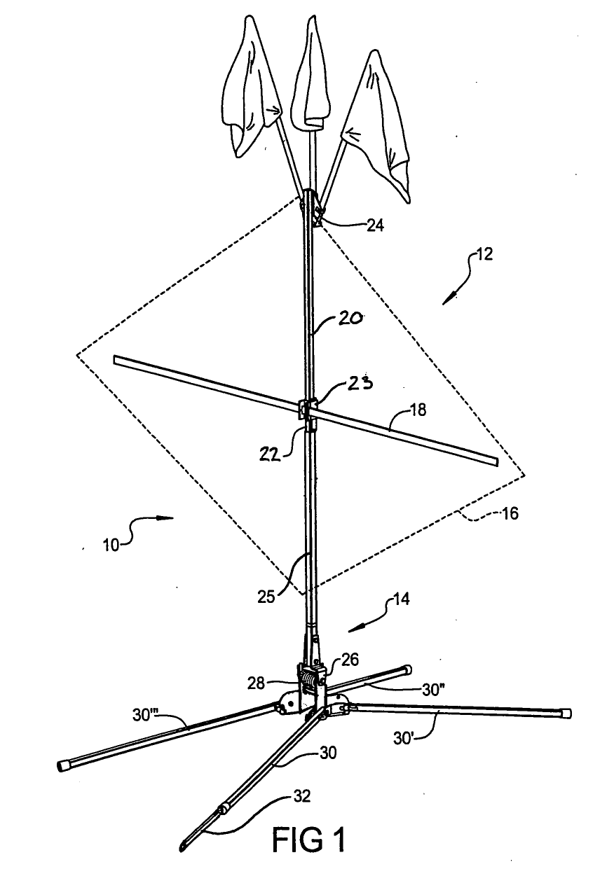

Referring generally to FIG. 1, a portable sign stand 10 of the present disclosure includes a sign assembly 12 which is supported from a ground surface using a torsion spring base or support assembly 14. Sign assembly 12 includes a sign 16 which can be held in an extended position using a sign brace 18. Sign brace 18 can be connected to and supported from an upright member 20. Upright member 20 is in turn connected to a first end of a coupling 22 which can also provide support for a brace bracket 23 to fix sign brace 18 to upright member 20. An upper sign support bracket 24 connected to upright member 20 is further used to hold an upper portion of sign 16 as well as any additional items such as one or more warning flags (shown), warning lights, or reflectors (not shown).

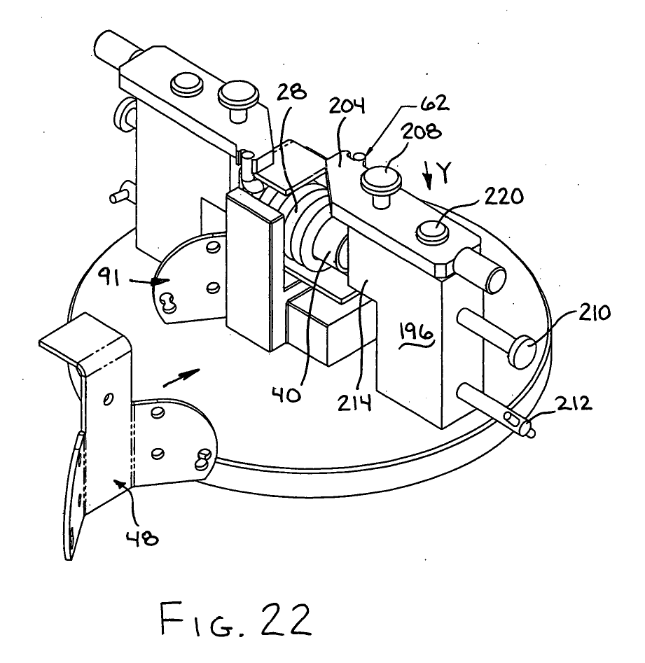

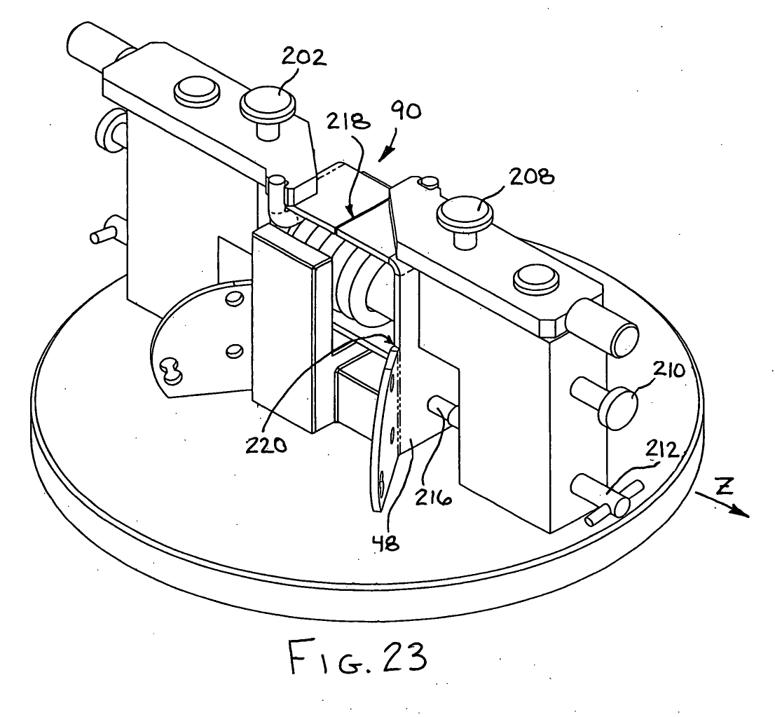

A first end of a mast 25 is connected into a second end of coupling 22. Mast 25 can be connected at a second end using for example a plurality of fasteners (not shown) to support assembly 14. Support assembly 14 includes a base assembly 26 having a torsionally pre-loaded horizontal torsion spring 28 positioned therein. A plurality of leg members 30, including leg members 30, 30′, 30″, and 30′″, are rotatably connected to base assembly 26. Leg members 30 are shown in an extended or support position and can be folded as further shown in reference to FIGS. 20 and 21 which will be described in greater detail herein. An extendable leg portion 32 (only one shown) can telescopically extend from each of the leg members 30, 30′, 30″, 30′″ respectively. Extendable leg portion 32 provides a broader footprint for portable sign stand 10 to resist overturning in high wind conditions.

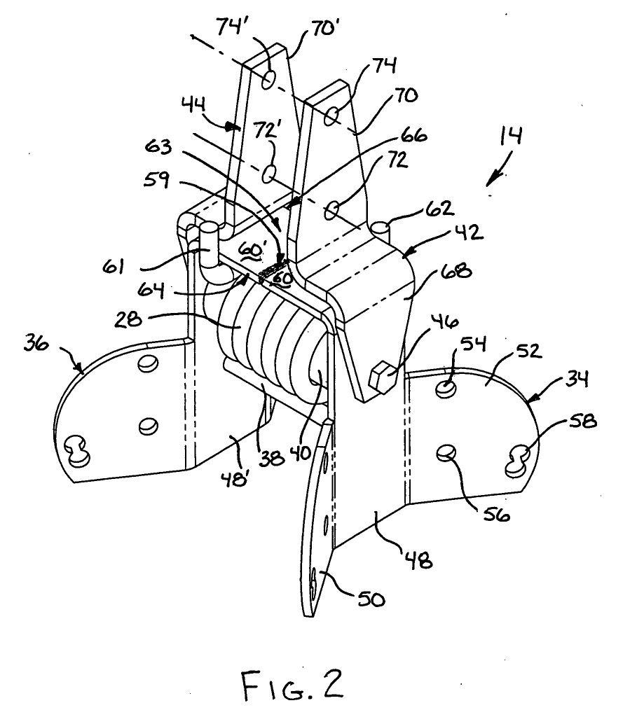

Referring now to FIG. 2, support assembly 14 includes a first bracket member 34 and a substantially identical and oppositely configured second bracket member 36. First and second bracket members 34, 36 can be connected below torsion spring 28 by a connecting member 38 which can be welded to each of first and second bracket members 34, 36. A spring support tube or receiving member 40 which in several embodiments can be tubular shaped is also positioned between each of first and second bracket members 34, 36 and above connecting member 38. According to several embodiments, spring receiving member 40 is freely positioned having opposed ends in contact with first and second bracket members 34, 36, but can also be fixed such as by welding at opposed ends to one or both first and second bracket members 34, 36. Horizontal torsion spring 28 is retained by being slidably disposed over a periphery of spring support tube or spring receiving member 40.

Support assembly 14 also includes first and second Z-brackets 42, 44. Second Z-bracket 44 is substantially identical to first Z-bracket 42 and is oppositely oriented. Both first and second Z-brackets 42, 44 are secured using a fastener 46 through a bracket portion 48, 48′ of each of first and second bracket members 34, 36. Fastener 46 also extends through spring receiving member 40. By tightening fastener 46 until bracket portions 48, 48′ contact ends of spring receiving member 40, both spring receiving member 40 and therefore torsion spring 28 are releasably fixed in position.

Because each of first and second bracket members 34, 36 are substantially identical, the following items are used on each. A first leg 50 and a second leg 52 are formed for example by bending at a junction with bracket portion 48. A plurality of apertures are created in each of first and second legs 50, 52. These include a first aperture 54, a second aperture 56, and a third extended aperture 58. First, second, and third apertures 54, 56, 58 receive either through fasteners (not shown in this view) to rotatably retain leg members 30, or releasable pins which allow leg members 30 to be rotated between a stowed and an extended position.

A weld joint 59 such as a fillet or butt weld can be created between each of a leg 60 and a leg 60′ of first and second bracket members 34, 36. Torsion spring 28 includes two ends which define upstanding (extending away from a coiled outer diameter of the main body of torsion spring 28) first and second spring posts 61, 62. In a non-loaded or relaxed condition, first and second spring posts 61, 62 are angled toward each other. Weld joint 59 is completed after each of the first spring post 61 and the second spring post 62 of horizontal torsion spring 28 are rotated away from each other, which creates a pre-load force retained by torsion spring 28. When connected, first and second bracket members 34, 36 create a base bracket 63 having opposed first and second walls defining opposed first and second end faces or edges 64, 66. In several embodiments spring posts 61, 62 are rotated away from each other until positioned substantially parallel to each other and retained in this condition by contact with first edge 64 and opposed second edge 66, respectively, of legs 60, 60′. By separating first and second spring posts 61, 62 using first legs 60, 60′ the torsion force or preload is applied to torsion spring 28. The preload is retained by the creation of weld joint 59 which prevents legs 60, 60′ from rotatably sliding relative to each other.

Each of the first and second Z-brackets 42, 44 include a first bracket flange 68, a second bracket flange 70 and at least first flange apertures 72, 72′, and in several embodiments second flange apertures 74, 74′, created in second bracket flanges 70, 70′, respectively. The first flange apertures 72, 72′ are co-axially aligned with respect to each other. Similarly; the second flange apertures 74, 74′ are co-axially aligned with respect to each other. Co-axial alignment of the first and second flange apertures 72, 72′ and 74, 74′ permits fasteners to be slidably received through the flange apertures as well as through corresponding apertures (not shown) created in mast 25.

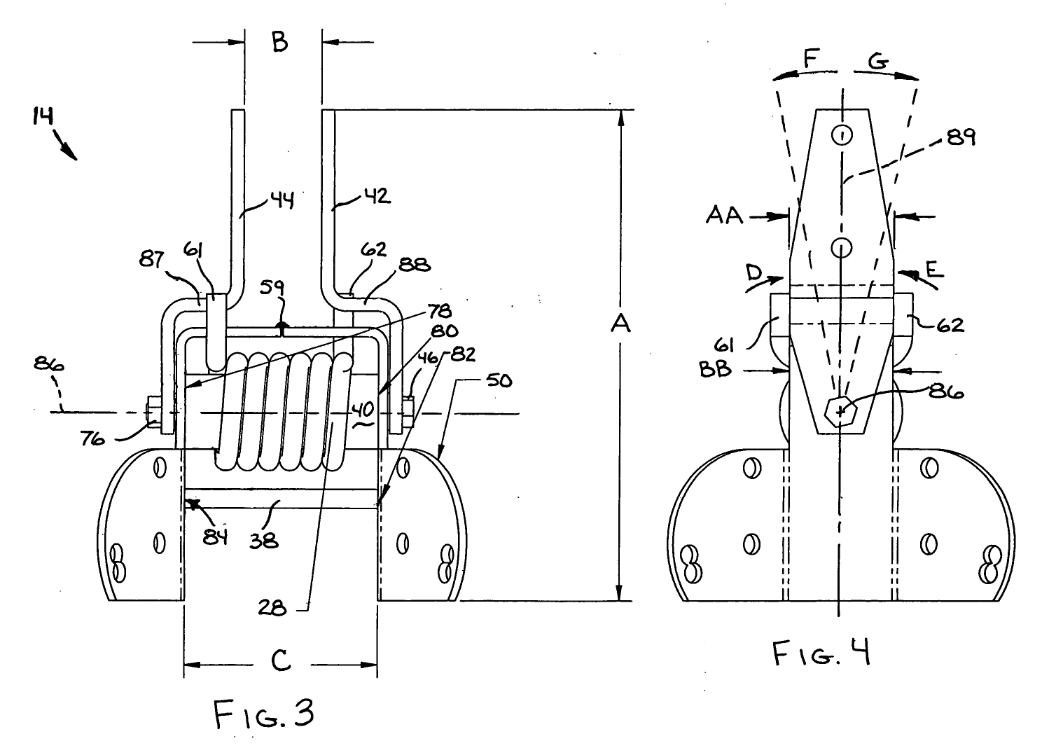

Referring now to FIG. 3, assembly of support assembly 14 is completed when a nut 76 is tightened to a free end of fastener 46. According to several embodiments, support assembly 14 can further include a first spring receiving member weld joint 78, and a second spring receiving member weld joint 80 at opposed ends of spring receiving member 40 if spring receiving member 40 is fixedly connected to bracket portions 48, 48′. Similarly, a first connecting member weld joint 82 and a second connecting member weld joint 84 can be used to join opposed ends of connecting member 38 to each of bracket portions, 48, 48′. When support assembly 14 is complete, fastener 46 with nut 76 in a tightened position defines an axis of rotation 86 for each of first and second Z-brackets 42, 44.

As further identified in FIGS. 3 and 4, when support assembly 14 is complete, the assembly has a total assembly height “A”, a mast receiving clearance dimension “B”, and a spring clearance dimension “C”. According to several embodiments, total assembly height “A” can be approximately 9.75 inches (24.8 cm), mast receiving clearance dimension “B” can be approximately 1.5 inches (3.8 cm), and spring clearance dimension “C” can be approximately 3.75 inches (9.5 cm). These dimensions do not limit the present disclosure and are provided as examples only, and can vary at the discretion of the manufacturer. In order to transfer the torsion spring preload force to maintain mast 25 substantially vertical orientation, first and second Z-brackets 42, 44 have a width “AA” at least equal to or greater than a width “BB” of first legs 60, 60′ of first and second brackets 34, 36. Therefore, in the assembled condition first spring post 61 contacts a leg portion 87 of second Z-bracket 44, and second spring post 62 contacts a leg portion 88 of first Z-bracket 42.

Referring now to FIGS. 1 and 4, as previously noted, width “AA” of both leg portions 87, 88 of the second and first Z-brackets 44, 42, respectively, is substantially equal to or greater than a corresponding width “BB” of first legs 60, 60′. When a load or force such as a wind force is applied to sign 16, this force is transferred through upright member 20 and mast 25 to each of first and second Z-brackets 42, 44.

For purposes of the following discussion, any bending of upright member 20 and/or mast 25 are ignored. Initially, the preload force retained by torsion spring 28 after rotating or repositioning each of first and second spring posts 61, 62 away from each other by the width “BB” of flanged ends 60, 60′ between the first and second edges 64, 66 of the bracket 63 increases a spring post spacing with respect to when the torsion spring 28 is in the non-loaded condition. This creates equal and opposed bias forces between first and second spring posts 61, 62. A first bias force acts through first spring post 61 in a first force direction “D”. A second bias force acts through second spring post 62 in a second force direction “E” which is substantially equal to and opposite the first bias force in first force direction “D”. These equal and balanced bias forces act to position and retain first and second Z-brackets 42, 44 and therefore mast 25 in a substantially vertical position defined by a vertical axis 89. When a sufficient second load or force such as a wind force is applied to sign 16 to overcome either the first or second bias forces provided through first or second spring posts 61, 62, a deflection about either a first deflection arc “F” or a second deflection arc “G” can occur about axis of rotation 86. When the second force applied to sign 16 is removed, sign 16, upright member 20, and mast 25 return by the opposed one of the first or second bias forces to the substantially vertical position defined by vertical axis 89. Because of the preload force applied to first and second spring posts 61, 62, a force tending to deflect sign 16 is immediately met by a counter-acting force in either of the first or second force directions “D”, or “E”. There is no rotation or displacement of upright member 20, mast 25, or first and second Z-brackets 42, 44 without deflection of first or second spring post 61 or 62. Support assembly 14 therefore continuously resists a force acting on sign 16 tending to deflect sign 16 from the vertical orientation.

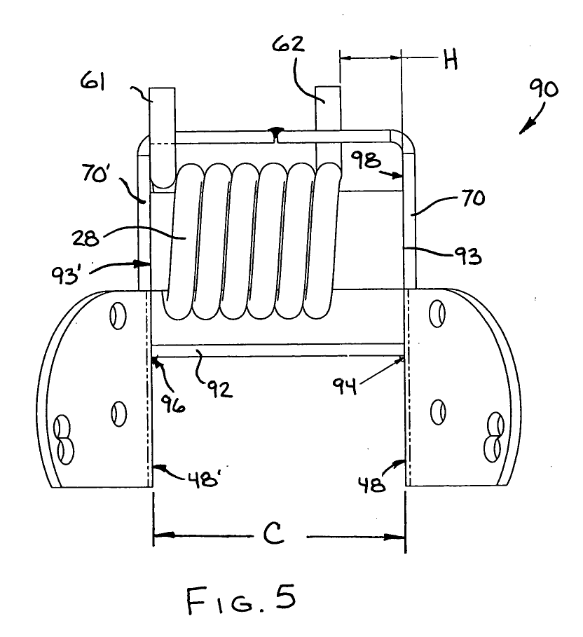

As best seen in reference to FIG. 5, a support assembly 90 is modified from support assembly 14. The connecting member 38 of support assembly 14 is replaced in support assembly 90 by a plate 92 welded at opposed ends using a first plate weld joint 94 and a second plate weld joint 96. Spring support member 40 is in contact at opposed ends 93, 93′ with second bracket flanges 70, 70′ of plate portions 48, 48′. Clearance is provided for torsion spring 28 to slide in either a left-to-right or right-to-left direction. This clearance is common to all of the support assemblies of the present disclosure. For example, when first spring post 61 abuts with second bracket flange 70′, a spring post clearance “H” is created between second spring post 62 and an inner-face 98 of second bracket flange 70. According to several embodiments spring post clearance “H” is approximately 0.9 inches (2.3 cm). Spring clearance dimension “C” therefore provides a spring installation tolerance when torsion spring 28 is installed. Spring clearance dimension “C” further enables first and second spring posts 61, 62 to be laterally spaced further apart to allow for additional turns or coils of torsion spring 28. This allows the manufacturer to choose between torsion springs of different coil quantities, sizes, and/or spring rates.

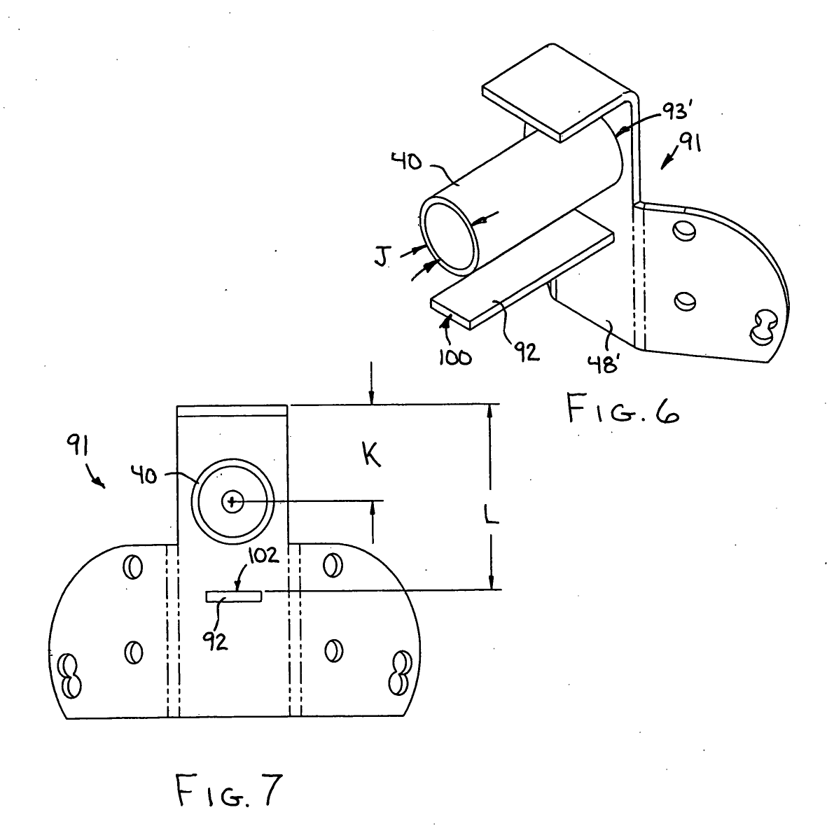

Referring now to FIG. 6, a sub-assembly 91 of support assembly 90 includes spring receiving member 40 and plate 92 pre-assembled or welded at spring receiving member first end 93′ to bracket portion 48′ below a wing or flange 99, and having a spring receiving member second end 93 freely extending away from bracket portion 48′. Spring receiving member 40 has an outer diameter “J” about which horizontal torsion spring 28 is slidably disposed. An end wall 100 of plate 92 defines the surface in contact with opposed bracket portion 48 when support assembly 90 is completed.

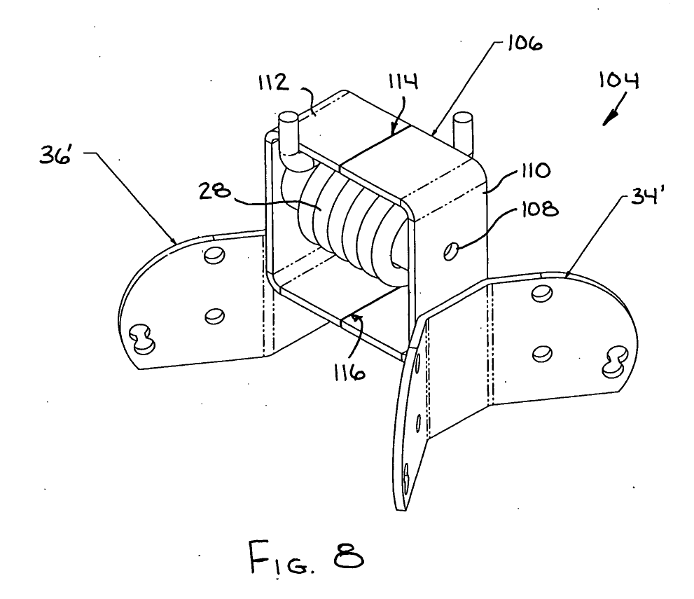

As best seen in reference to FIG. 7, spring receiving member 40 is positioned at a member spacing dimension “K” and plate 92 is positioned at a plate spacing dimension “L”, respectively, from an upper surface 101 of flange 99. A clearance for the coil thickness of horizontal torsion spring 28 from an upwardly oriented face 102 of plate 92 and below is therefore provided by spacing dimensions “K” and “L”.

Referring now generally to FIG. 8, according to additional embodiments of the present disclosure a support sub-assembly 104 is further modified from support assembly 14. Support sub-assembly 104 includes a rectangular-shaped bracket assembly 106 with a fastener through-aperture 108 created in each of the opposed walls defined by a first U-shaped bracket portion 110 and a second U-shaped bracket portion 112. First and second U-shaped bracket portions 110,112 are fixedly connected using a first weld joint 114 and a second weld joint 116 similar to weld joint 59. Rectangular bracket assembly 106 is then fixedly attached for example by fillet or spot welding to each of a modified first bracket member 34′ and a modified second bracket member 36′.

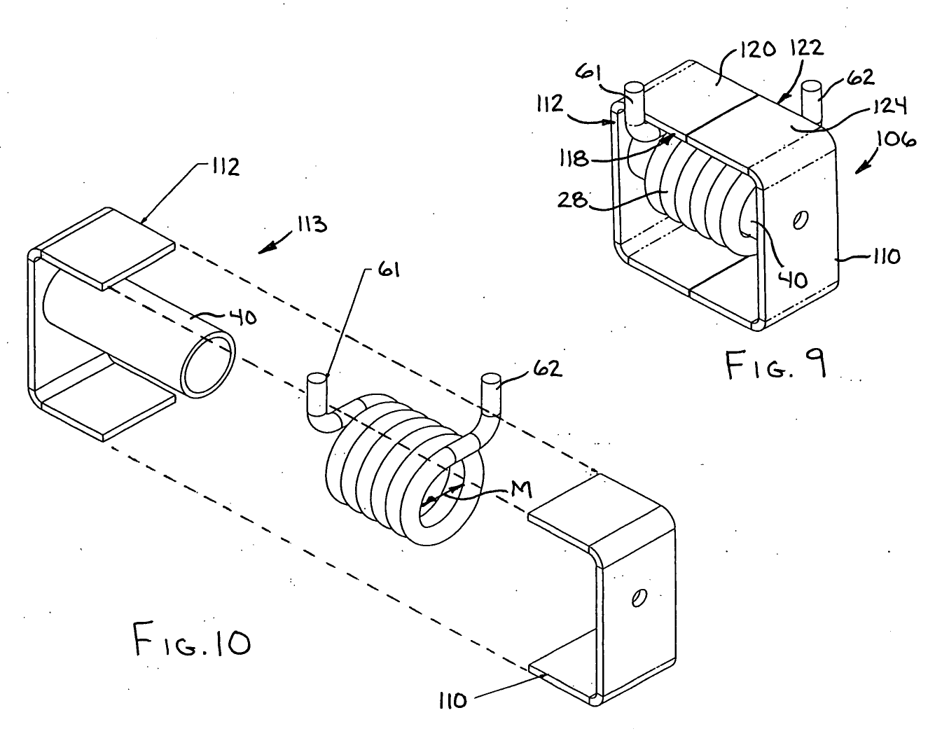

Referring now to FIG. 9, rectangular bracket assembly 106 can use spring receiving member 40 to support horizontal torsion spring 28 therein. When assembled and a preload force is applied to torsion spring 28, first spring post 61 is biased into contact with a side edge 118 of an extending leg 120 of second U-shaped bracket portion 112, and second spring post 62 is biased into contact with a side edge 122 of an extending leg 124 of first U-shaped bracket portion 110. When assembled as shown, first and second spring posts 61, 62 are oriented substantially parallel to each other which retains the pre-load on torsion spring 28 similar to support assembly 14.

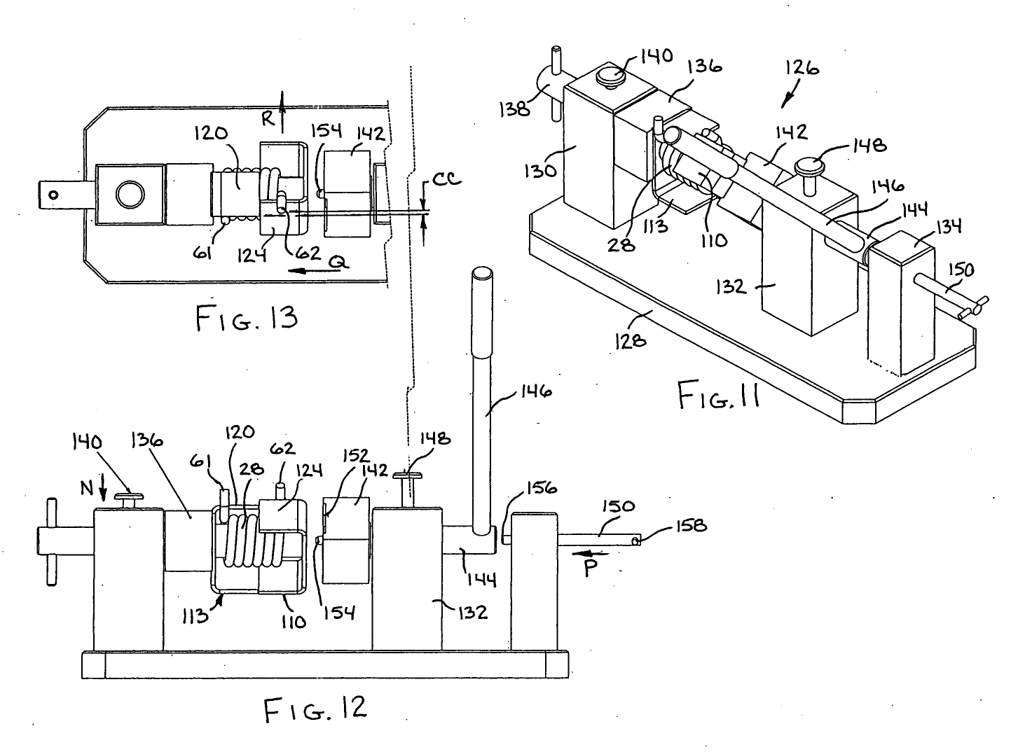

As shown in FIG. 10, the assembly of rectangular bracket assembly 106 of FIG. 9 is created by positioning or fixedly connecting spring receiving member 40 as shown at second U-shaped bracket portion 112. Torsion spring 28 is then slidably disposed about the perimeter of spring receiving member 40 such that a spring inner diameter “M” of torsion spring 28 is slidably received over spring receiving member 40. Spring inner diameter “M” is larger than the tube outer diameter “J” of spring receiving member 40 to allow a sliding fit. If spring receiving member 40 is fixedly connected to second U-shaped bracket portion 112, a bracket sub-assembly 113 is created.

With reference now to FIG. 11, a method for applying the pre-load force to the horizontal torsion springs, such as torsion spring 28, for creating the support assemblies of the present disclosure can be through the use of a fixture. A spring preload and assembly welding fixture 126 includes a base 128 having each of a first post 130, a second post 132, and a third post 134 fixedly connected thereto. A first bracket support member 136 is rotatably connected to first post 130 using a first support shaft 138. A first engagement pin 140 is provided through a free end of first post 130. First engagement pin 140 is initially retracted to allow free rotation of first support shaft 138 and therefore to position first bracket support member 136 at a pre-determined position. When the pre-determined position is reached, first engagement pin 140 is pressed or inserted into an engaged position with first support shaft 138 to temporarily prevent further rotation of first support shaft 138 and first bracket support member 136.

Bracket sub-assembly 113 of bracket assembly 106 can be held in place by first bracket support member 136, for example by magnetic attraction if first bracket support member 136 is a magnetic material or is magnetized. In the alternative, bracket subassembly 113 can be temporarily fixed to first bracket support member 136.

A second bracket support member 142 is rotatably connected to second post 132 by a second support shaft 144. Second support shaft 144 can be manually rotated using a handle 146. A second engagement pin 148 similar to first engagement pin 140 is slidably disposed in second post 132 to either engage with or release for rotation second support shaft 144. Second bracket support member 142 in the present operation temporarily holds first U-shaped bracket portion 110 of rectangular bracket assembly 106.

As an alternate method to rotate second support shaft 144, a drive shaft 150 can be used. Drive shaft 150 is rotatably engaged with third post 134. Drive shaft 150 can be either manually rotated or rotated using a power tool (not shown).

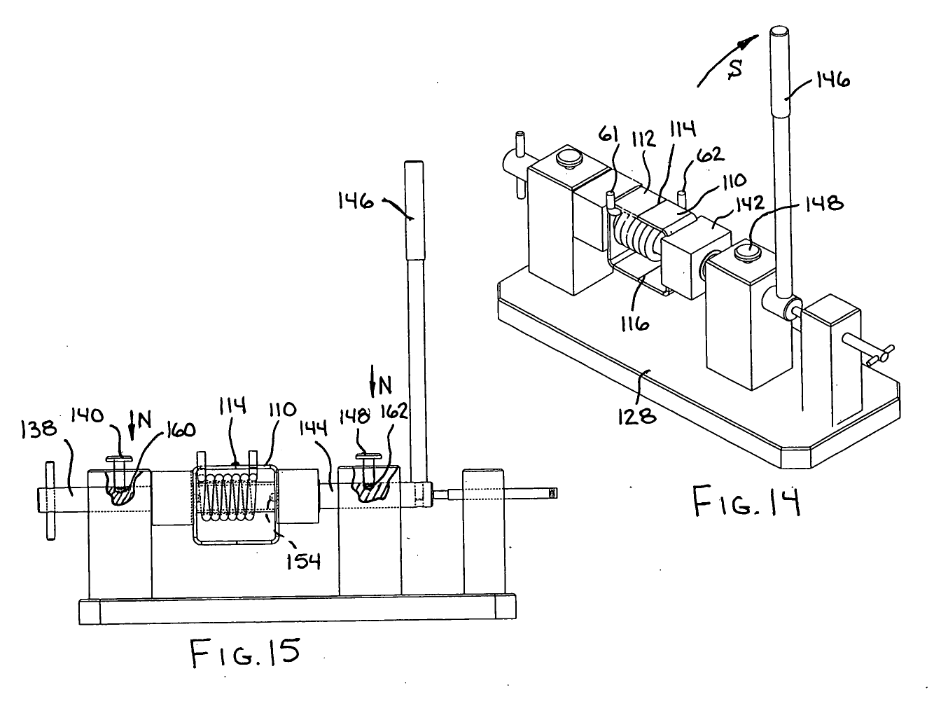

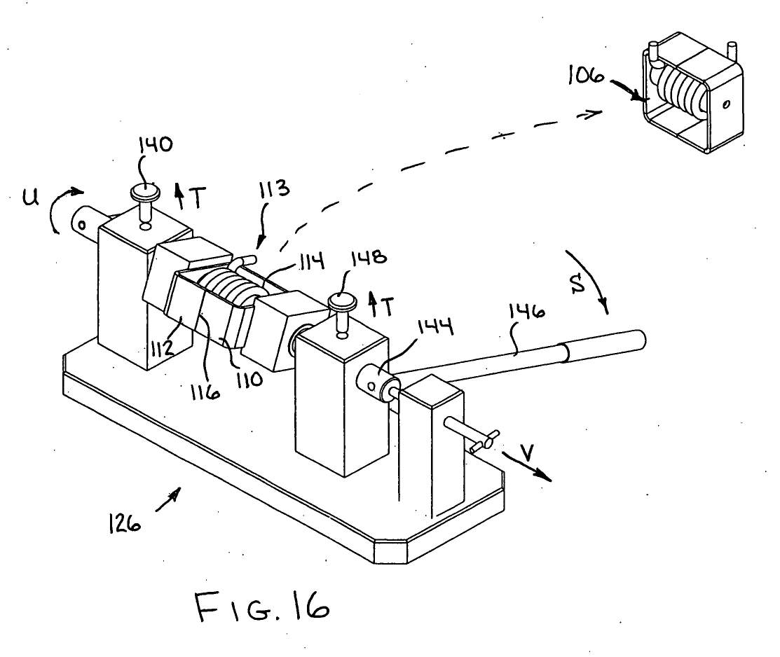

Referring now to FIGS. 12 and 13, bracket subassembly 113 is temporarily fixed to first bracket support member 136 having extending leg 120 in contact with first spring post 61 of torsion spring 28. By rotating first bracket support member 136, first spring post 61 is oriented together with bracket subassembly 113 to position first spring post 61 in the substantially vertical position shown. First bracket support member 136 is locked by pressing first engagement pin 140 into contact with first support shaft 138 in a pin engagement direction “N”. With first spring post 61 vertically oriented, first spring post 61 is separated from second spring post 62 by a gap or dimension “CC” when torsion spring 28 is in the relaxed or non-loaded condition.

First U-shaped bracket portion 110 is positioned as shown and engaged in a recess 152 created in second bracket support member 142 while simultaneously receiving a centering pin 154 extending outwardly from second bracket support member 142. To engage second bracket support member 142 and centering pin 154 with first U-shaped bracket portion 110, second support shaft 144 and second bracket support member 142 are displaced in a support member engagement direction “Q”. By rotating handle 146, second bracket support member 142 rotates first U-shaped bracket portion 110 and thereby extending leg 124 and second spring post 62 in a preload inducing direction “R”.

Instead of rotating handle 146, drive shaft 150 can be driven in a shaft engagement direction “P” until an engagement drive end 156 contacts the free end of second support shaft 144. Rotation of drive shaft 150 can also be induced by applying a rotational load on a drive pin 158 which is oriented substantially perpendicular to a longitudinal access of drive shaft 150.

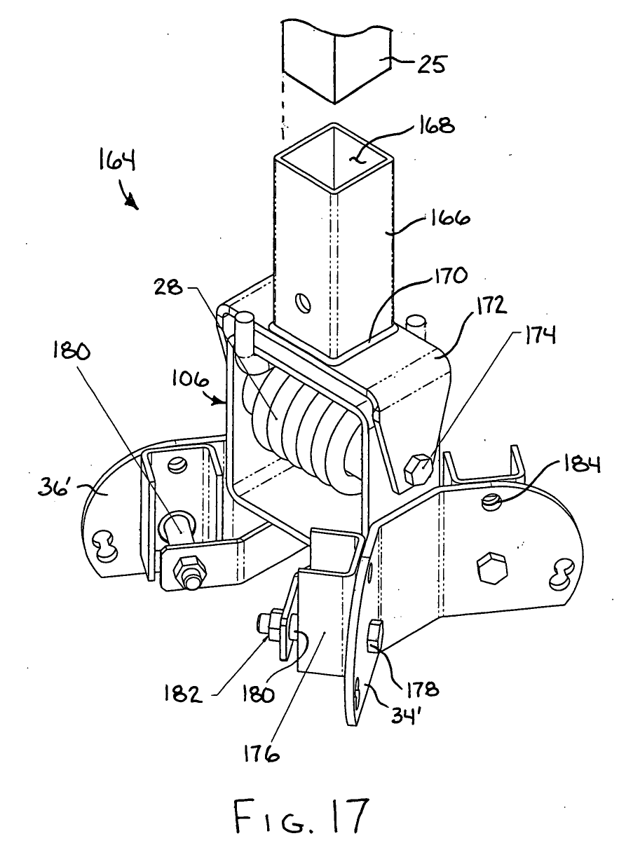

As best seen in reference to FIGS. 14 and 15, handle 146 is rotated in a handle arc of rotation “S” until first U-shaped bracket portion 110 is aligned with second U-shaped bracket portion 112. After alignment, second engagement pin 148 is inserted by pressing into engagement with second support shaft 144 to temporarily lock the assembly in place. In this condition, each of first and second spring posts 61, 62 are further separated from each other by the width of first and second U-shaped bracket portions 110, 112 defining a wider spacing between first and second spring posts 61, 62 than the spacing of non-loaded clearance “AA”. A preload is therefore applied to torsion spring 28 which is retained by applying first weld joint 114 and second weld joint 116.

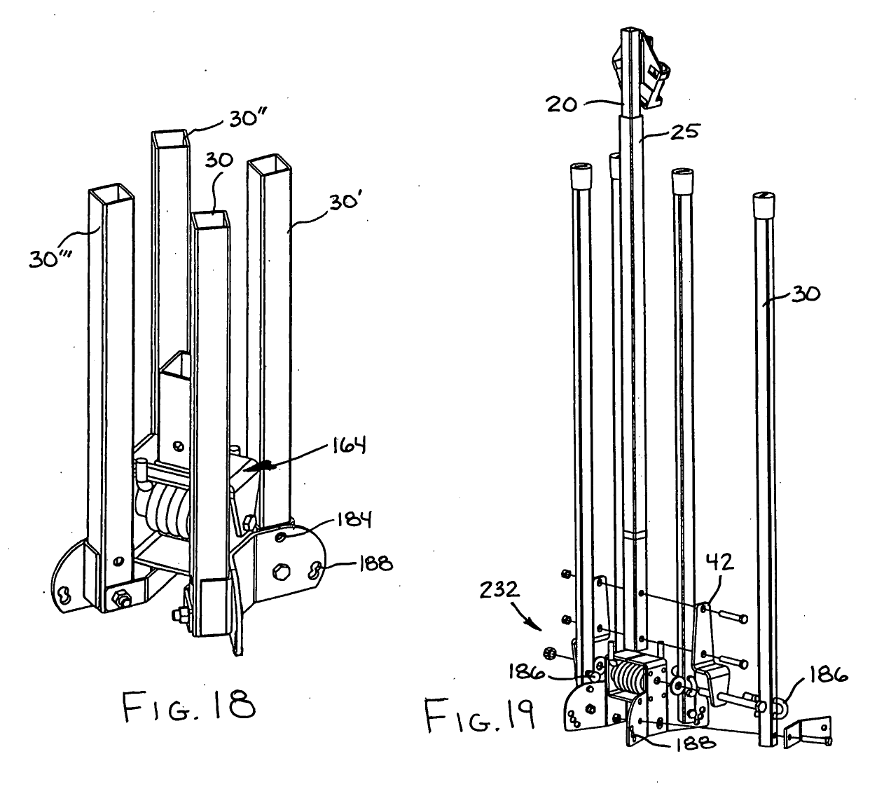

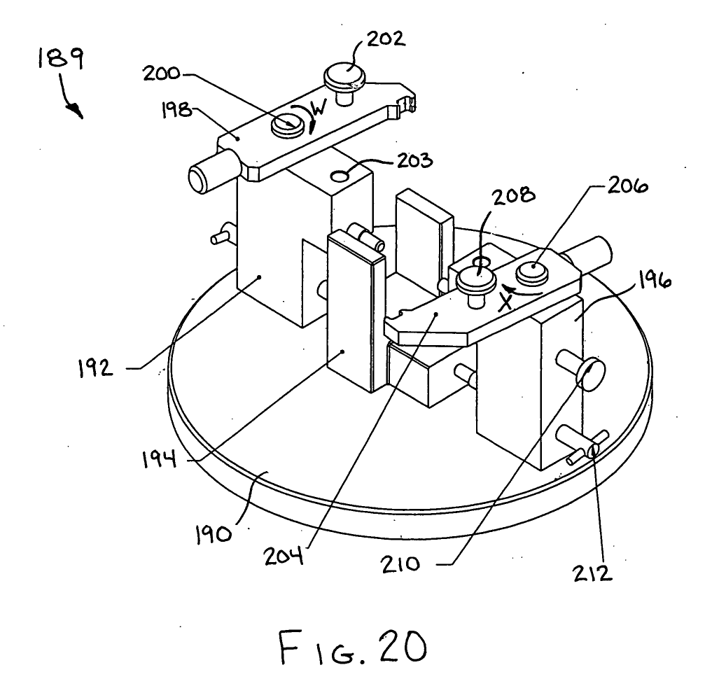

As best seen in reference to FIG. 15, when first engagement pin 140 is inserted in the pin engagement direction “N” an end of first engagement pin 140 is received within a pin cavity 160 created in first support shaft 138. Similarly, when second engagement pin 148 is inserted in the pin engagement direction “N” an end of second engagement pin 148 is received within a pin cavity 162 created in second support shaft 144. The preload applied to torsion spring 28 which would otherwise tend to return handle 146 in an arc of rotation opposite to handle arc of rotation “S” is restrained by engagement of first and second engagement pins 140, 148. It is apparent from FIGS. 16 and 17 that access to make first weld joint 114 is provided by the orientation of first U-shaped bracket portion 110 and second U-shaped bracket portion 112, however, access to make second weld joint 116 can be restricted in this orientation.

Bracket assembly 106 can be reoriented for access to create second weld joint 116 by the following steps. A tack weld can be made to prevent separation of first U-shaped bracket portion 110 and second U-shaped bracket portion 112 due to the preload force of torsion spring 28. First engagement pin 140 is then released by translating first engagement pin 140 in a pin release direction “T”. Similarly, second engagement pin 148 is released by translation in the pin release direction “T”. By further rotating handle 146 about handle arc of rotation “S”, bracket subassembly 113 and first U-shaped bracket portion 110 are co-rotated about an arc of rotation “U” until corresponding second legs of first and second U-shaped bracket portions 110, 112 are positioned as shown to complete second weld joint 116. Once assembly and welding of bracket assembly 106 is completed, second support shaft 144 is displaced in a member release direction “V” permitting rectangular bracket assembly 106 to be removed from fixture 126.

With reference now to FIG. 17, a support assembly 164 is further modified from support assembly 14 to include a tube 166 fixedly connected by a weld joint 170 to a U-shaped bracket 172. A shape of tube 166 generally corresponds to a shape of mast 25, which in the example shown is generally rectangular-shaped. Mast 25 can also have other geometric shapes, not limited to circular, oval, triangular, and the like within the scope of the present disclosure. Mast 25 is slidably received within a correspondingly shaped cavity 168 of tube 166. U-shaped bracket 172 is rotatably connected to bracket assembly 106 using a through fastener 174 similar to fastener 46. Support assembly 164 further includes four leg collars 176 each connected to an individual branch of the respective first and second bracket members 34′, 36′. Leg collars 176 can be attached using a leg fastener 178, a spacer tube 180, and a nut 182. Each of leg collars 176 is therefore adapted to support one of the leg members 30 (not shown in this view) for rotation between each of the stowed and the extended positions by engagement through a pin engagement aperture 184 with a releasable engagement pin 186 (shown in FIG. 21).

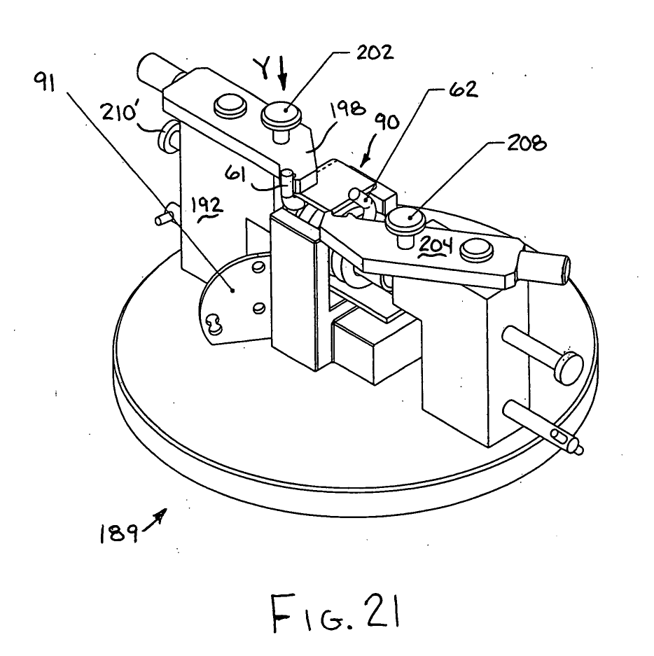

Referring generally now to FIGS. 18 and 19, support assembly 164 and support assembly 232 (to be described in greater detail in reference to FIG. 25), are shown each having a plurality of leg members 30 positioned in their upright or stowed positions. Releasable pin engagement apertures 184 are provided to retain each of the leg members 30 in the upright position, and multi-engagement apertures 188 are provided to retain the leg members 30 in the extended position (shown in FIG. 1). By releasing individual ones of a plurality of engagement pins 186, each of the leg members 30 can be rotated from the stowed position shown to the extended position and fixed in one of several extended orientations having the engagement pins 186 inserted through the multi-engagement apertures 188.

Referring generally now to FIG. 20, support assemblies of the present disclosure can also be assembled using a spring preload and assembly welding fixture 189. Fixture 189 differs from fixture 126 by the use of different rotating members. Fixture 189 includes a rotatable plate 190 having a first base bracket 192, a center bracket 194, and a second base bracket 196 fixedly connected thereto. A first turning arm 198 is rotatably connected to first base bracket 192 using a pivot pin 200 which allows first turning arm 198 to rotate about a first arm arc of rotation “W”. A stop pin 202 is also provided with first turning arm 198 which performs a similar function as first and second engagement pins 140, 148 of fixture 126 by releasably engaging in a pin receiving cavity 203 created in first base bracket 192. A second turning arm 204 is rotatably connectable to second base bracket 196 using a pivot pin 206 which allows rotation of second turning arm 204 about a second arm arc of rotation “X”. A stop pin 208 is also provided with second turning arm 204 and functions similar to stop pin 202. A base pin 210 is axially movable in second base bracket 196 and a screw member 212 is also axially movable in second base bracket 196.

With reference now to FIG. 21, subassembly 91 is shown positioned within fixture 189 having first turning arm 198 rotated to a contact position with first spring post 61 of torsion spring 28. Stop pin 202 is engaged in a pin engagement direction “Y” with first base bracket 192 to hold first spring post 61 in the substantially vertical position shown. Second spring post 62 is shown in a relaxed or non-loaded position prior to a preload force being applied to torsion spring 28 by second turning arm 204.

Referring now to FIG. 22, second spring post 62 is shown in its after-preloading position with second turning arm 204 rotated to the position shown and stop pin 208 engaged with second base bracket 196 to temporarily restrain further rotation of second turning arm 204. The preload applied to torsion spring 28 is thereby temporarily retained. Each of base pin 210 and screw member 212 are fully retracted to permit the second half of support assembly 90, including bracket portion 48, to be disposed between spring receiving member 40 and an extending member 214 of second base bracket 196.

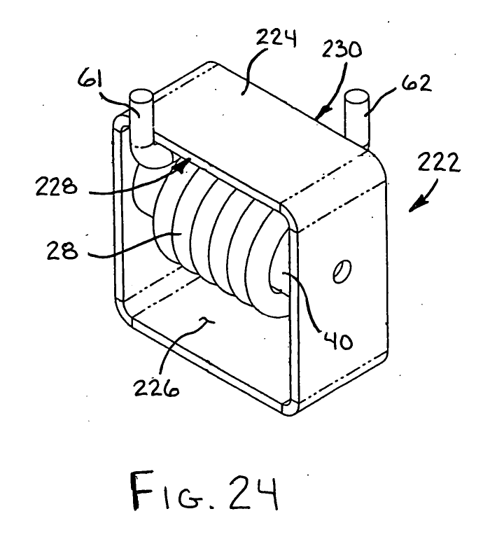

With reference now to FIG. 23, with bracket portion 48 positioned as shown, base pin 210 is inserted into a locking relationship with fastener through-aperture 108 (not visible in this view) and screw member 212 is fully inserted and engaged with bracket portion 48 to restrain bracket portion 48. A weld joint 218 and a weld joint 220 (not clearly visible in this view) are then created to complete support assembly 90. Once completed, support assembly 90 is removed from fixture 189 by withdrawing both base pin 210 and screw member 212 and releasing each of stop pins 202 and 208. Base pin 210 and screw member 212 are released in a release direction “Z”.

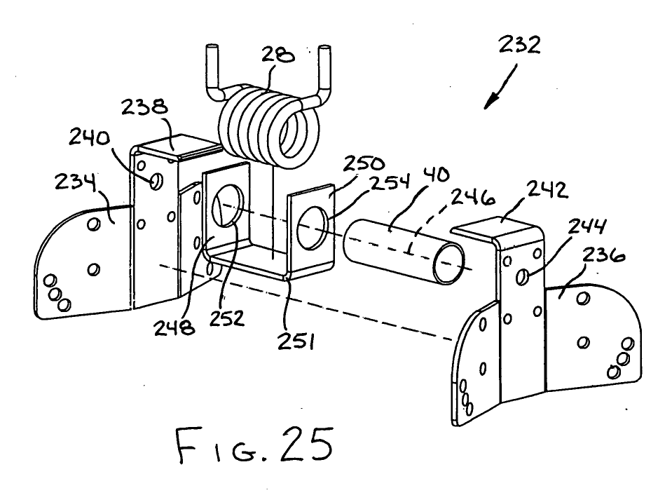

Referring now to FIG. 24, a bracket assembly 222 differs from bracket assembly 106 shown in FIG. 9 by eliminating the weld joints 114, 116 created as shown in FIG. 18. Because rotation of the two bracket portions 110, 112 is not required in this embodiment to preload torsion spring 28, the weld joints are not required. A geometrically shaped body 224 of bracket assembly 222 can be made by cutting a predetermined length from an extruded or formed tube. Torsion spring 28 is first slidably disposed over spring receiving member 40 and the assembly of torsion spring 28 and spring receiving member 40 is positioned within a cavity 226 of tubular body 224. First and second spring posts 61, 62 are then separated to create the spring preload and are engaged with opposed outer edges 228, 230 of tubular body 224 to create and retain the spring preload.

Referring to FIG. 25, a support assembly 232 is modified from support assembly 14 to include a first bracket member 234 and a second bracket member 236 which is substantially identical to and oppositely oriented from first bracket member 234. First bracket member 234 includes a leg 238 and a fastener receiving aperture 240. Second bracket member 236 includes a leg 242 alignable and connectable to leg 238, and a fastener receiving aperture 244 coaxially alignable with fastener receiving aperture 240 defining a central axis 246. Torsion spring 28 is received between opposed first and second wings 248, 250 of a generally C-shaped bracket 251. An aperture 252 is provided in first wing 248 and a similar aperture 254 is provided in second wing 250 which both are sized to slidably receive spring receiving member 40 which as previously described herein retains torsion spring 28. With spring receiving member coaxially aligned with central axis 246, leg 238 is welded to leg 242 and a fastener such as fastener 46 is inserted through fastener receiving apertures 240, 244 to complete construction of support assembly 232.

A torsion spring base for a deflectable sign of the present disclosure provides several advantages. By applying a preload force of a horizontally arranged torsion spring to a bracket connected to a sign support mast, the preload force acts to constantly bias the mast to an upright or vertical orientation. Any secondary force such as a wind load applied to the sign connected to the mast must overcome the preload force before the mast and sign will deflect. Common deflectable sign supports allow the mast to deflect through a small arc before engaging a spring element, or deflect against a normally non-loaded or relaxed spring element. This permits the mast to deflect away from a vertical axis with minimal wind loading, or to immediately deflect with a slight wind load, which detracts from the appearance and function of the sign. Under certain conditions, this motion permits the mast to accelerate before striking the spring which applies a hammer load to the spring which can damage the spring or sign support. The preloaded torsion spring base of the present disclosure normally maintains the mast and sign in a vertical orientation until a predetermined wind load or secondary force deflects the mast and sign away from vertical. When the secondary force is removed, a bias force of the torsion spring automatically returns the mast and sign to the vertical position. The preloaded torsion spring base of the present disclosure also prevents an unbiased motion of the sign or an unrestricted acceleration of the mast and subsequent hammer load from damaging the sign support member.

What is claimed is:

1. A deflectable sign spring base, comprising:
a base bracket having opposed first and second walls defining opposed first and second edges; and
a horizontally configured torsion spring positioned between the first and second walls, the torsion spring having ends defining upstanding first and second spring posts, the first spring post in contact with the first edge of the base bracket and the second spring post in contact with the second edge of the base bracket;
wherein a base bracket width between the first and second edges is greater than a spring post spacing when the torsion spring is in a non-loaded condition, such that engagement of the first and second spring posts with the first and second edges induces a preload force in the torsion spring.

2. The torsion spring base of claim 1, further comprising a spring receiving member having the torsion spring disposed over the spring receiving member, the spring receiving member positioned between and contacting at opposed ends each of the first and second walls.

3. The torsion spring base of claim 2, further comprising:
first and second Z-brackets each having a fastener receiving aperture; and
a sign support mast connected to both the first and second Z-brackets;
wherein the first and second Z-brackets are each rotatably connected to one of the first and second walls using a fastener insertable through the fastener receiving aperture of each of the Z-brackets, through an aperture created in each of the first and second walls, and through the spring receiving member, the first and second Z-brackets each having a width at least equal to the base bracket width between the first and second edges such that the preload force of the torsion spring is constantly applied by the first spring post to the first Z-bracket and by the second spring post to the second Z-bracket to bias the sign support mast toward a substantially vertical orientation.

4. The torsion spring base of claim 2, further comprising:
a U-shaped sign support bracket having opposed wings each having a fastener receiving aperture;
wherein the spring receiving member defines a tubular member having a hollow passage; and
wherein the sign support bracket is rotatably connected to the base bracket using a fastener insertable through the fastener receiving aperture of each of the opposed wings and through an aperture created in both the first and second walls and through the hollow passage of the spring receiving member.

5. The torsion spring base of claim 4, further comprising a tubular member fixedly connected to the sign support bracket and adapted to slidably receive a corresponding tubular-shaped sign support mast.

6. The torsion spring base of claim 2, further comprising a cross-connect member positioned proximate the spring receiving member and fixedly connected at opposed ends to individual ones of the fist and second walls.

7. The torsion spring base of claim 6, wherein the cross-connect member comprises a circular rod.

8. The torsion spring base of claim 7, wherein the cross-connect member comprises a plate.

9. The torsion spring base of claim 2, wherein the base bracket comprises first and second bracket portions each defining a substantially C-shaped body having opposed, substantially parallel first and second legs joined by a transverse flange member, wherein the base bracket defines a substantially rectangular shape.

10. The torsion spring base of claim 9, wherein the first leg of the first bracket portion and the first leg of the second bracket portion are alignable and weldable together, and the second leg of the first bracket portion and the second leg of the second bracket portion are alignable and weldable together to create a generally rectangular shape for the base bracket.

11. The torsion spring base of claim 10, wherein
the first leg of the first bracket portion defines the first edge having the first spring post in contact with the first edge; and
the first leg of the second bracket portion defines the second edge having the second spring post in contact with the second edge;
wherein the second bracket portion is rotatable to achieve alignment of the first and second bracket portions, the first and second bracket portions fixable together to define the base bracket width between the first and second edges.

12. The torsion spring base of claim 1, further comprising first and second leg support members fixedly connected to the bracket, the first and second leg support members each adapted to rotatably engage at least one leg member.

13. The torsion spring base of claim 1, further comprising a member adapted to engage a sign support mast rotatably connected to the base bracket and in contact with both the first and second spring posts, wherein the member and the sign support mast are continuously urged to a substantially vertical orientation by the preload force of the torsion spring until acted on by a second force operable to overcome the preload force, the preload force thereafter being operable to return the sign support mast to the vertical orientation following removal of the second force.

14. A deflectable sign spring base, comprising:
a substantially rectangular-shaped base bracket having opposed first and second bracket walls;
a horizontally configured torsion spring disposed between the bracket walls and having first and second spring posts, the first spring post in contact with a first edge of the base bracket and the second spring post in contact with an opposed second edge of the base bracket, a spacing between the first and second edges being greater than a spring post spacing in a spring non-loaded condition, such that engagement of the first and second spring posts with the first and second edges separates the spring posts and induces a preload force in the torsion spring; and
a member adapted to engage a sign support mast rotatably connected to the base bracket and in continuous contact with both the first and second spring posts, wherein the member and the sign support mast are continuously urged to a substantially vertical orientation by the preload force of the torsion spring until acted on by a second force operable to overcome the preload force, the preload force thereafter being operable to return the member and the sign support mast to the vertical orientation following removal of the second force.

15. The torsion spring base of claim 14, further comprising a spring support member positioned in a cavity of the torsion spring and in contact with the first and second bracket walls.

16. The torsion spring base of claim 15, wherein the spring support member further comprises a tubular shape having a hollow cavity.

17. The torsion spring base of claim 15, wherein the member further comprises first and second Z-brackets each having a fastener receiving aperture adapted to receive a fastener also disposed through an aperture created in each of the first and second walls and the hollow cavity of the spring support member.

18. The torsion spring base of claim 15, wherein the member further comprises a U-shaped bracket having opposed wings, each wing having a fastener receiving aperture adapted to receive a fastener also disposed through an aperture created in each of the first and second walls and the hollow cavity of the spring support member.

19. The torsion spring base of claim 14, further comprising first and second leg support members fixedly connected to the base bracket, the first and second leg support members each adapted to rotatably engage at least one leg member.

20. The torsion spring base of claim 19, further comprising a telescoping leg portion slidably extendable from each of the leg members.

21. A fixture adapted for assembling a deflectable sign spring base, comprising:
a first bracket support member adapted to releasably retain a first bracket portion and a torsion spring, the torsion spring having a first spring post in contact with the first bracket portion;
a second bracket support member adapted to releasably retain a second bracket portion in contact with a second spring post of the torsion spring; and
a rotation inducing member operable to rotate the second bracket portion connected to the second bracket support member to induce a preload force in the torsion spring through increased rotational separation of the first and second spring posts.

22. The fixture of claim 21, further comprising:
a first support shaft engaged with the first bracket support member and adapted to rotate the first bracket portion; and
a second support shaft engaged with the second bracket support member and adapted to rotate the second bracket portion into contact with the second spring post of the torsion spring.

23. The fixture of claim 22, further comprising:
a first stop pin operable to non-rotatably lock the first support bracket and the first bracket portion together; and
a second stop pin operable to non-rotatably lock the second support bracket and the second bracket portion together with the second bracket portion aligned with the first bracket portion and the preload force induced in the torsion spring.

24. The fixture of claim 23, further comprising:
a fixture base;
a first post fixed to the base and adapted to rotatably receive the first support shaft;
a second post fixed to the base and adapted to rotatably receive the second support shaft; and
a handle defining the rotation inducing member connected to the second support shaft operable to rotate the second support shaft.

25. A method for configuring a deflectable sign spring base, the spring base having first and second bracket portions, a torsion spring having first and second spring posts, and a sign support member, the method comprising:
disposing the torsion spring horizontally between the bracket portions having the first spring post in contact with the first bracket portion and the second spring post in contact with the second bracket portion; and
rotatably aligning the bracket portions to induce a preload force in the torsion spring through the first and second spring posts.

26. The method of claim 25, further comprising fixedly connecting the first and second bracket portions after the first and second bracket portions are rotatably aligned.

27. The method of claim 25, further comprising rotatably connecting a member adapted to engage a sign support mast to the bracket and in continuous contact with both the first and second spring posts.

28. The method of claim 27, further comprising continuously urging the member and the sign support mast to a substantially vertical orientation by the preload force of the torsion spring until the member and the sign support mast are acted on by a second force operable to overcome the preload force, the preload force thereafter operably returning the member and the sign support mast to the vertical orientation following removal of the second force.

29. A method for constructing a deflectable sign spring base, the spring base having a bracket member, a torsion spring having first and second spring posts, and a sign support member, the method comprising:
disposing the torsion spring horizontally within a cavity of the bracket member;
rotatably separating the first and second spring posts to apply a preload force to the torsion spring;
engaging the first and second spring posts with opposing edges of the bracket member to retain the preload force; and
rotatably connecting the sign support member to the bracket member.

30. The method of claim 29, further comprising fixing opposed bracket leg members to the bracket member.

31. The method of claim 30, further comprising: rotatably connecting at least one leg to each of the bracket leg members.
